(19) United States
(12) Patent Application Publication
(10) Pub. No.: US 2026/0064024 A1
(43) Pub. Date: Mar. 5, 2026

(54) CARRIER FOR DEVELOPING ELECTROSTATIC CHARGE IMAGE, ELECTROSTATIC CHARGE IMAGE DEVELOPER, PROCESS CARTRIDGE, IMAGE FORMING APPARATUS, IMAGE FORMING METHOD, AND METHOD FOR PRODUCING CARRIER FOR DEVELOPING ELECTROSTATIC CHARGE IMAGE

(71) Applicant: FUJIFILM Business Innovation Corp., Tokyo (JP)

(72) Inventors: Shintaro ANNO, Kanagawa (JP); Yasuo KADOKURA, Kanagawa (JP)

(73) Assignee: FUJIFILM Business Innovation Corp., Tokyo (JP)

(21) Appl. No.: 19/382,143

(22) Filed: Nov. 6, 2025

Related U.S. Application Data
(62) Division of application No. 17/948,795, filed on Sep. 20, 2022.

(30) Foreign Application Priority Data
Feb. 4, 2022 (JP) 2022-016749

(51) Int. Cl. G03G 9/113; G03G 9/08; G03G 9/107; G03G 15/08

(52) U.S. Cl. CPC G03G 9/1139; G03G 9/0819; G03G 9/108; G03G 9/1131; G03G 15/08

(57) ABSTRACT

A carrier for developing an electrostatic charge image includes magnetic particles and a coating layer covering the magnetic particles, the coating layer containing a resin and inorganic particles, containing 20 parts by mass or more and 60 parts by mass or less of the inorganic particles per 100 parts by mass of the resin. The percentage exposure of the magnetic particles on the surface is 0% or more and 5% or less, and, in a cross-sectional observation, either there is no gap between the magnetic particles and the coating layer, or a gap lies at least in part between the magnetic particles and the coating layer, occupying a percentage area of 0% or more and 5% or less.

### CROSS-REFERENCE TO RELATED APPLICATIONS

This application is a Divisional application of U.S. patent application Ser. No. 17/948,795 filed Sep. 20, 2022, which is based on and claims priority under 35 USC 119 from Japanese Patent Application No. 2022-016749 filed Feb. 4, 2022.

### BACKGROUND

### (i) Technical Field

The present disclosure relates to a carrier for developing an electrostatic charge image, an electrostatic charge image developer, a process cartridge, an image forming apparatus, an image forming method, and a method for producing a carrier for developing an electrostatic charge image.

### (ii) Related Art

Japanese Unexamined Patent Application Publication No. 2017-181575 discloses a carrier for two-component developers. The carrier includes magnetic particles and a resin coating layer covering the magnetic particles, and the weight-average molecular weight of the resin(s) in the resin coating layer is between 1,800,000 and 5,000,000.

Japanese Unexamined Patent Application Publication No. 2021-135470 discloses a carrier for developing an electrostatic charge image. The carrier includes magnetic particles and a resin layer containing inorganic particles. The percentage exposed area of the magnetic particles is 0.1% or more and 4.0% or less, and the average diameter of the inorganic particles is 5 nm or more and 90 nm or less. The ratio B/A is 1.020 or greater and 1.100 or smaller, where A and B are the area in plan view and the surface area, respectively, of the carrier in a three-dimensional analysis of its surface.

### SUMMARY

Aspects of non-limiting embodiments of the present disclosure relate to a carrier for developing an electrostatic charge image. This carrier may help prevent voids in an image, compared with those having, when a cross-section is observed, a gap at least in part between magnetic particles and a coating layer, with the gap occupying a percentage area exceeding 5%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a carrier for developing an electrostatic charge image, the carrier including magnetic particles and a coating layer covering the magnetic particles, the coating layer containing a resin and inorganic particles, containing 20 parts by mass or more and 60 parts by mass or less of the inorganic particles per 100 parts by mass of the resin, wherein: a percentage exposure of the magnetic particles on a surface is 0% or more and 5% or less; and, in a cross-sectional observation, either there is no gap between the magnetic particles and the coating layer, or a gap lies at least in part between the magnetic particles and the coating layer, occupying a percentage area of 0% or more and 5% or less.

### BRIEF DESCRIPTION OF THE DRAWINGS

Exemplary embodiments of the present disclosure will be described in detail based on the following figures, wherein:

FIG. 1 presents cross-sectional schematics of carrier particles;

FIG. 2 is a schematic diagram illustrating the structure of an example of an image forming apparatus according to an exemplary embodiment; and

FIG. 3 is a schematic diagram illustrating the structure of an example of a process cartridge, according to an exemplary embodiment, attachable to and detachable from an image forming apparatus.

### DETAILED DESCRIPTION

The following describes exemplary embodiments of the present disclosure. The following description and Examples are for illustrative purposes and do not limit the scope in which aspects of the present disclosure can be embodied.

Numerical ranges specified herein with “A-B,” “between A and B,” “(from) A to B,” etc., represent inclusive ranges, which include the minimum A and the maximum B as well as all values in between.

The following description also includes series of numerical ranges. In such a series, the upper or lower limit of a numerical range may be substituted with that of another in the same series. The upper or lower limit of a numerical range, furthermore, may be substituted with a value indicated in the Examples section.

A gerund or action noun used in relation to a certain process or method herein does not always represent an independent action. As long as its purpose is fulfilled, the action represented by the gerund or action noun may be continuous with or part of another.

An exemplary embodiment herein may be described with reference to drawing(s). The reference, however, does not mean what is illustrated is the only possible configuration of the exemplary embodiment. The size of elements in each drawing is conceptual; the relative sizes of the elements do not need to be as illustrated.

An ingredient herein may be a combination of multiple substances. If a composition described herein contains a combination of multiple substances as one of its ingredients, the amount of the ingredient represents the total amount of the substances in the composition unless stated otherwise.

An ingredient herein, furthermore, may be a combination of multiple kinds of particles. If a composition described herein contains a combination of multiple kinds of particles as one of its ingredients, the diameter of particles of the ingredient is that of the mixture of the multiple kinds of particles present in the composition unless stated otherwise.

As used herein, the term “(meth)acrylic” refers to at least one of acrylic or methacrylic, and “(meth)acrylate” refers to at least one of an acrylate or a methacrylate.

A “toner for developing an electrostatic charge image” may be referred to as “toner” herein. Likewise, a “carrier for developing an electrostatic charge image” may be referred to as a “carrier,” and an “electrostatic charge image developer” may be referred to as a “developer.”

### Carrier for Developing an Electrostatic Charge Image

A carrier according to an exemplary embodiment includes magnetic particles and a coating layer covering the magnetic particles.

The coating layer of the carrier according to this exemplary embodiment contains at least one resin and inorganic particles, containing 20 parts by mass or more and 60 parts by mass or less of the inorganic particles per 100 parts by mass of the resin. A resin in this context is a base resin for the coating layer. If the coating layer contains resin particles, the resin particles and a base resin are different elements.

On the surface of the carrier according to this exemplary embodiment, the percentage exposure of the magnetic particles is 0% or more and 5% or less.

When a cross-section of the carrier according to this exemplary embodiment is observed, either there is no gap between the magnetic particles and the coating layer, or a gap lies at least in part between the magnetic particles and the coating layer, occupying a percentage area of 0% or more and 5% or less.

The gap between the magnetic particles and the coating layer is that seen when a cross-section of the carrier is observed by embedding particles of the carrier in a piece of resin, cutting the resin to give a slice, and observing the slice. (The details of the observation and measurement are described later herein.)

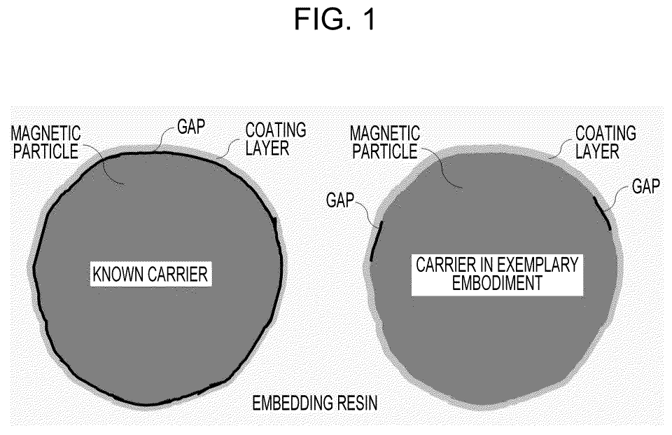

FIG. 1 presents cross-sectional schematics of carriers, illustrating resin-embedded carrier particles.

On the left of FIG. 1 is a schematic view of a particle of a known carrier. The carrier particle in this part of the drawing has a gap entirely between the magnetic particle and the coating layer. The coating layer detaches from the magnetic particle during the preparation of the slice, creating a gap entirely in the boundary.

On the right of FIG. 1 is a schematic view of a particle of the carrier according to this exemplary embodiment. The carrier particle in this part of the drawing has gaps partially between the magnetic particle and the coating layer. Part of the coating layer detaches from the magnetic particle during the preparation of the slice, creating gaps partially in the boundary.

A slice prepared from the carrier according to this exemplary embodiment has no gap between the magnetic particles and the coating layer by virtue of strong adhesion therebetween. Even if there is a gap, the inventors believe, it is confined to part of the boundary. In this exemplary embodiment, the percentage area of gaps between the magnetic particles and the coating layer is a measure of bonding between the magnetic particles and the coating layer. Smaller percentage areas of gaps indicate stronger bonding between the magnetic particles and the coating layer.

The coating layer of the carrier according to this exemplary embodiment does not easily peel off the magnetic particles, allowing the carrier to maintain its coating structure and remain resistant even after prolonged stirring inside the developer unit. The carrier according to this exemplary embodiment, therefore, does not easily migrate toward the photoconductor, and this may help prevent voids in an image.

The carrier according to this exemplary embodiment may help prevent voids especially when used to form a 100% density (or “solid”) image under hot and humid conditions (e.g., a temperature of 28.5° C. and a relative humidity of 85%) after continuous formation of low-density images, a situation in which voids caused by carrier migration are frequent.

The coating layer of the carrier according to this exemplary embodiment contains 20 parts by mass or more and 60 parts by mass or less of the inorganic particles per 100 parts by mass of the resin.

If the inorganic particles content of the coating layer of the carrier is less than 20 parts by mass per 100 parts by mass of the resin, only scarce inorganic fine particles are available to the resin in the coating layer. The filler effect on mechanical strength is small, and part of the coating layer will detach easily from the carrier surface when the carrier is stirred by the developer unit. The resistance will decrease, resulting in frequent voids in an image. For this reason, the inorganic particles content is 20 parts by mass or more per 100 parts by mass of the resin. The inorganic particles content may be 25 parts by mass or more, preferably 30 parts by mass or more.

If the inorganic particles content of the coating layer of the carrier exceeds 60 parts by mass per 100 parts by mass of the resin, too many inorganic fine particles are available to the resin in the coating layer. Although the coating layer is very hard by virtue of the filler effect, the adhesion of the coating layer is not sufficiently strong. Part of the coating layer, therefore, will detach easily from the carrier surface when the carrier is stirred by the developer unit, and a decrease in resistance will result in frequent voids in an image. For this reason, the inorganic particles content is 60 parts by mass or less per 100 parts by mass of the resin. The inorganic particles content may be 50 parts by mass or less, preferably 40 parts by mass or less.

On the surface of the carrier according to this exemplary embodiment, the percentage exposure of the magnetic particles is 0% or more and 5% or less.

If the percentage exposure of the magnetic particles on the surface of the carrier exceeds 5%, the coating layer will easily detach at its interfaces with the exposed portions of the magnetic particles when the carrier undergoes stress from being stirred by the developer unit. The resistance will decrease, resulting in frequent voids in an image. For this reason, the percentage exposure of the magnetic particles is 5% or less. This percentage may be 4% or less, preferably 3% or less.

The percentage exposure of the magnetic particles on the surface of the carrier may be 1% or more because this may encourage stable image formation by ensuring uniform triboelectric charging of the toner(s) and the carrier through the creation of microscopic electrical paths by the exposed portions of the magnetic particles. Preferably, this percentage is 2% or more, more preferably 3% or more.

When a cross-section of the carrier according to this exemplary embodiment is observed, either there is no gap between the magnetic particles and the coating layer, or a gap lies at least in part between the magnetic particles and the coating layer, occupying a percentage area of 0% or more and 5% or less to the total area of the carrier.

If the percentage area of the gap to the total area of the carrier exceeds 5%, the detachment of the coating layer will easily proceed at the region spaced apart from the magnetic particles when the carrier undergoes stress from being stirred by the developer unit. The resistance will decrease, resulting in frequent voids in an image. For this reason, the percentage area of the gap is 5% or less. The percentage area of the gap may be even smaller; it may be 4% or less, preferably 3% or less.

The percentage area of the gap to the total area of the carrier may be 0.05% or more so that the gap between the coating layer and the magnetic particles will buffer the impact of collision between carrier particles when the carrier is exposed to stress from being stirred by the developer unit, thereby allowing the carrier to remain resistant. Preferably, this percentage is 0.1% or more, more preferably 0.2% or more.

In this exemplary embodiment, the percentage exposure of the magnetic particles on the carrier surface is that determined by x-ray photoelectron spectroscopy (XPS) as follows.

The elemental composition of the carrier surface is analyzed using JPS-9000MX analyzer (JEOL Ltd.) in Normal depth mode with an x-ray intensity of 10 kV/30 mA. The percentage (%) of the area of the peak for Fe to the total area of the peaks for C, O, N, Fe, Mn, Mg, and Sr, which are common elements in ordinary carriers, is calculated and reported as the percentage exposure (%) of the magnetic particles.

In this exemplary embodiment, the percentage area of the gap between the magnetic particles and the coating layer is that measured through the observation of a cross-section of the carrier as follows.

A portion of the carrier is mixed into epoxy resin, and the epoxy resin is cured. The resulting solid is cut using an ultramicrotome to give a slice having a thickness of 100 nm or more and 200 nm or less. The slice is observed with a field-emission scanning electron microscope (FE-SEM; e.g., Hitachi High-Technologies S-4800) at a magnification of 5000 times, and the cross-section is imaged. The cross-sectional image is analyzed using image analysis software (WinROOF 2015, Mitani Corporation) to determine the cross-sectional area of one carrier particle (the combined area of the magnetic particle, the coating layer, and the gap) and the area of the gap between the magnetic particle and the coating layer, and the percentage area (%) of the gap to the cross-sectional area of that carrier particle is calculated. The arithmetic mean of the percentage area (%) of the gap in 100 carrier particles is the percentage area of the gap.

The volume-average diameter of particles of the carrier may be 15 μm or more and 120 μm or less, preferably 20 μm or more and 100 μm or less, more preferably 30 μm or more and 80 μm or less. The volume-average diameter of particles refers to the diameter at which the cumulative volume is 50% in a size distribution by volume of the particles plotted starting from the smallest diameter.

The following describes the structure of the carrier according to this exemplary embodiment in detail.

### Magnetic Particles

The magnetic particles can be of any kind; known types of magnetic particles that can be used as a carrier core can be employed. Specific examples of magnetic particles include particles of magnetic metals, such as iron, nickel, and cobalt; particles of magnetic oxides, such as ferrite and magnetite; resin-impregnated magnetic particles, which are obtained by impregnating a porous magnetic powder with a resin; and magnetic powder-dispersed resin particles, which are particles of a resin with a magnetic powder dispersed therein.

In this exemplary embodiment, the magnetic particles may be ferrite particles for chargeability reasons.

The volume-average diameter of the magnetic particles may be 15 μm or more and 100 μm or less, preferably 20 μm or more and 80 μm or less, more preferably 30 μm or more and 60 μm or less. The volume-average diameter of particles in this context refers to the diameter at which the cumulative volume is 50% in a size distribution by volume of the particles plotted starting from the smallest diameter.

As for the magnetism of the magnetic particles, the saturation magnetization in a magnetic field of 3000 Oersteds is, for example, 50 emu/g or more and may be 60 emu/g or more. This saturation magnetization is that measured using VSM P10-15 vibrating sample magnetometer (Toei Industry). The sample for measurement is packed in a 7-mm (inner diameter)×5-mm (height) cell, and this cell is set in the magnetometer. A magnetic field is applied, swept up to 3000 Oersteds, and then reduced while a hysteresis loop is drawn on chart paper. Data from the loop is used to determine the saturation magnetization, remanent magnetization, and coercivity.

The electrical volume resistance (volume resistivity) of the magnetic particles may be 1×10⁵ Ω·cm or more and 1×10⁹ Ω·cm or less, preferably 1×10⁷ Ω·cm or more and 1×10⁹ Ω·cm or less.

The electrical volume resistance (Ω·cm) of the magnetic particles is that measured as follows. On the surface of a round jig having 20-cm² plate electrodes, the analyte particles are spread to form a flat layer with a thickness of 1 mm or more and 3 mm or less. A 20-cm² plate electrode is placed on this layer to sandwich the layer between the electrodes. A load of 4 kg is placed on the upper electrode to eliminate any space between the analyte particles, and then the thickness of the layer (cm) is measured. The two electrodes, on and below the layer, have been connected to an electrometer and a high-voltage power supply. A high voltage is applied to the electrodes to produce an electric field of 103.8 V/cm, and the current reading (A) is recorded. The measurement is performed at a temperature of 20° C. and a relative humidity of 50%, and the electrical volume resistance (Ω·cm) of the analyte is calculated according to the following equation.

$$R = E \times 20 / ( I - {I}_{0} ) / L$$

In the equation, R represents the electrical volume resistance (Ω·cm) of the analyte, E represents the applied voltage (V), I represents electrical current (A), I₀ represents the electrical current (A) at an applied voltage of 0 V, and L represents the thickness (cm) of the layer. The coefficient 20 is the area (cm²) of the plate electrodes.

### Coating Layer

The average thickness of the coating layer may be 0.2 μm or more and 3.0 μm or less, preferably 0.3 μm or more and 2.0 μm or less, more preferably 0.4 μm or more and 1.5 μm or less.

The average thickness of the coating layer is that determined by analyzing a cross-sectional image of 100 carrier particles using image analysis software.

Examples of base resins for the coating layer include styrene-acrylic resins; polyolefin resins, such as polyethylene and polypropylene; polyvinyl or polyvinylidene resins, such as polystyrene, acrylic resins, polyacrylonitrile, polyvinyl acetate, polyvinyl alcohol, polyvinyl butyral, polyvinyl chloride, polyvinylcarbazole, polyvinyl ethers, and polyvinyl ketones; vinyl chloride-vinyl acetate copolymers; straight silicone resins, formed by organosiloxane bonds, and their modified forms; fluoropolymers, such as polytetrafluoroethylene, polyvinyl fluoride, polyvinylidene fluoride, and polychlorotrifluoroethylene; polyesters; polyurethanes; polycarbonates; amino resins, such as urea-formaldehyde resins; and epoxy resins.

Styrene-acrylic resins, when used as base resins for the coating layer, may adhere well to the magnetic particles (ferrite particles in particular).

Examples of monomers that can be polymerized into a styrene-acrylic resin include lower alkyl esters of (meth)acrylic acid (e.g., C1 to C9 alkyl (meth)acrylates), specifically methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. One such monomer may be used, or two or more may be used in combination.

The percentage of styrene-acrylic resins to all base resins for the coating layer may be 80% by mass or more, preferably 90% by mass or more. It may be that substantially all base resins are styrene-acrylic resins.

The coating layer contains inorganic particles. The inorganic particles are an element different from the electrically conductive particles described below. An example of inorganic particles is silica particles.

Silica particles may adhere well the base resin for the coating layer (styrene-acrylic resins in particular).

The silica particles content of the coating layer may be 20 parts by mass or more, preferably 25 parts by mass or more, more preferably 30 parts by mass or more per 100 parts by mass of the base resin.

The silica particles content of the coating layer may be 60 parts by mass or less, preferably 50 parts by mass or less, more preferably 40 parts by mass or less per 100 parts by mass of the base resin.

The average diameter of primary particles of the inorganic particles may be 1 nm or more and 80 nm or less as this may help the particles adhere well to the base resin for the coating layer. Preferably, this average diameter is 5 nm or more and 50 nm or less, more preferably 5 nm or more and 30 nm or less.

The average diameter of primary particles of the inorganic particles is that determined by analyzing, using image analysis software, inorganic particles included in a cross-sectional image of 100 carrier particles.

The average diameter of primary particles of silica particles may be 1 nm or more and 80 nm or less as this may help the particles adhere well to the base resin for the coating layer. Preferably, this average diameter is 5 nm or more and 50 nm or less, more preferably 5 nm or more and 30 nm or less.

The coating layer may contain resin particles, for example for the purpose of further increasing the mechanical strength of the layer. The resin particles are an element different from the base resin for the coating layer. The resin particles are observed as particles inside the coating layer in a cross-sectional image of the carrier.

Examples of resin particles include particles of a crosslinking resin and particles of a thermosetting resin.

Examples of crosslinking resins include crosslinking styrene-acrylic resins.

Examples of thermosetting resins include melamine, urea, urethane, guanamine, and amide resins.

The amount of resin particles, if contained, in the coating layer may be 3 parts by mass or more and 30 parts by mass or less per 100 parts by mass of the base resin. Preferably, the resin particles content is 4 parts by mass or more and 25 parts by mass or less, more preferably 5 parts by mass or more and 20 parts by mass or less.

The coating layer may contain electrically conductive particles for the control of the charge or resistance of the carrier. Examples of electrically conductive particles include particles of carbon black; metals, such as gold, silver, and copper; metal compounds, such as barium sulfate, aluminum borate, potassium titanate, titanium oxide, zinc oxide, tin oxide, antimony-doped tin oxide, tin-doped indium oxide, and aluminum-doped zinc oxide; and metal-coated resin particles.

The amount of electrically conductive particles, if contained, in the coating layer may be 1 part by mass or more and 30 parts by mass or less per 100 parts by mass of the base resin. Preferably, the electrically conductive particles content is 2 parts by mass or more and 25 parts by mass or less, more preferably 3 parts by mass or more and 20 parts by mass or less.

The amount of the coating layer may be 1 part by mass or more and 10 parts by mass or less, preferably 1.5 parts by mass or more and 7 parts by mass or less, more preferably 2 parts by mass or more and 5 parts by mass or less per 100 parts by mass of the magnetic particles.

### Production of the Carrier for Developing an Electrostatic Charge Image

A carrier according to the above exemplary embodiment for developing an electrostatic charge image can be produced by any method. A production method in which an extruder is used, however, may help form a coating layer relatively rich in inorganic particles on magnetic particles. The use of an extruder may help achieve a 5% or smaller percentage exposure of the magnetic particles by helping form a coating layer highly uniform and relatively rich in inorganic particles on the magnetic particles, and may also help achieve a 5% or smaller percentage area of gaps seen in a cross-sectional observation of the carrier by helping improve the bonding between the magnetic particles and the coating layer.

An example of an extruder-based production method is one that includes dry-attaching base resin particles for the coating layer and the inorganic particles to the surface of the magnetic particles (attachment); and passing the magnetic particles, with the base resin particles and the inorganic particles adhering thereto, continuously through an extruder at a temperature at which the resin particles melt (processing through an extruder). The following describes the details of this production method.

### Attachment

Base resin particles for the coating layer (hereinafter “first resin particles”) and inorganic particles are dry-attached to the surface of magnetic particles. The term “dry” means the resin is not dissolved or dispersed in a solvent.

The first resin particles will melt, and form the base for the coating layer, during the processing through an extruder. The term “melt” in this context means the first resin particles fuse together, losing their shape. The first resin particles, therefore, are resin particles that will lose their shape during the processing through an extruder by virtue of their thermal characteristics.

Any resin particles different from the base resin (hereinafter “second resin particles”) that will be in the coating layer of the finished carrier are also attached to the magnetic particles. The second resin particles are resin particles that will not melt, and therefore maintain their shape, during the processing through an extruder.

Any electrically conductive particles that will be in the coating layer of the finished carrier are also attached to the magnetic particles.

The first resin particles and other material(s) may be attached to the surface of the magnetic particles with the help of mechanical impact. A specific example is to put the materials into a stirring mixer and stir them. The inside of the stirring mixer is at a temperature at which the first resin particles do not melt (i.e., a temperature at which the first resin particles maintain their shape).

### Processing Through an Extruder

The magnetic particles, with at least the first resin particles and the inorganic particles adhering thereto, are passed continuously through an extruder at a temperature at which the first resin particles melt. The term “melt” in this context means the first resin particles fuse together, losing their shape. By being processed through an extruder, the first resin particles melt and become pressed into the microscopic texture on the surface of the magnetic particles together with the inorganic particles, forming a highly adhesive coating layer.

An extruder is a device that applies pressure and heat to a material while transporting the material continuously. In general, the structure of an extruder is divided into three major components: a material inlet, a barrel, and an outlet, in order from upstream to downstream. The barrel is composed of a casing and screw(s) inside the casing. Around the casing is a heater that heats the inside of the casing. The extruder may be a single-screw or twin-screw one. A twin-screw extruder may be a typical example.

The length of time it takes for the particles to pass all the way through the extruder may be 0.1 minutes or more and 20 minutes or less, preferably 0.2 minutes or more and 15 minutes or less, more preferably 0.3 minutes or more and 10 minutes or less.

The inside of the barrel, or at least part of it, is at a temperature at which the first resin particles can fuse together. At least part of the inside of the barrel may be at the glass transition temperature of the first resin particles plus 105° C. or more and 300° C. or less, preferably the glass transition temperature of the first resin particles plus 105° C. or more and 280° C. or less, more preferably the glass transition temperature of the first resin particles plus 105° C. or more and 250° C. or less.

The temperature of the processed particles at the outlet may be the glass transition temperature of the first resin particles plus 105° C. or more and 280° C. or less, preferably the glass transition temperature of the first resin particles plus 105° C. or more and 260° C. or less, more preferably the glass transition temperature of the first resin particles plus 105° C. or more and 230° C. or less.

### Crushing and Cooling

The processing through an extruder may be followed by crushing and cooling, in which the processed particles are cooled while being crushed. In the crushing and cooling, the particles processed through the extruder are cooled while being crushed into primary particles.

Proactive cooling is unnecessary; the particles only need to be crushed at room temperature (e.g., an atmosphere between 5° C. and 35° C.). It is, furthermore, not critical how to crush the particles; a known mixer or mill can be used.

The crushing and cooling may be followed by classification or sieving. It is not critical how to classify or sieve the particles; a known classifier or sieve can be used.

### Electrostatic Charge Image Developer

A developer according to an exemplary embodiment contains toner and a carrier according to the above exemplary embodiment.

The developer according to this exemplary embodiment is one prepared by mixing appropriate proportions of toner and a carrier according to the above exemplary embodiment. The mix ratio (by mass) between the toner and the carrier may be between 1:100 (toner:carrier) and 30:100, preferably between 3:100 and 20:100.

### Toner for Developing an Electrostatic Charge Image

The toner can be of any kind and can be a known one. An example is a colored toner including toner particles that contain binder resin(s) and coloring agent(s). An infrared-absorbing toner, made with infrared absorber(s) instead of coloring agent(s), may also be used. The toner may contain ingredients like a release agent and internal or external additives.

### Binder Resin(s)

Examples of binder resins include vinyl resins that are homopolymers of monomers such as styrenes (e.g., styrene, para-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene) and copolymers of two or more such monomers.

Non-vinyl resins, such as epoxy resins, polyester resins, polyurethane resins, polyamide resins, cellulose resins, polyether resins, and modified rosin, mixtures of any such resin and vinyl resin(s), and graft copolymers obtained by polymerizing a vinyl monomer in the presence of any such non-vinyl resin may also be used.

One such binder resin may be used alone, or two or more may be used in combination.

A binder resin may be, for example, a polyester resin. Examples of polyester resins include known ones.

The glass transition temperature (Tg) of the polyester resin may be 50° C. or above and 80° C. or below, preferably 50° C. or above and 65° C. or below.

The glass transition temperature is that determined from the DSC curve of the resin, which is measured by differential scanning calorimetry (DSC). More specifically, the glass transition temperature is the “extrapolated initial temperature of glass transition” as in the methods for determining glass transition temperatures set forth in JIS K7121-1987 “Testing Methods for Transition Temperatures of Plastics.”

The weight-average molecular weight (Mw) of the polyester resin may be 5000 or more and 1000000 or less, preferably 7000 or more and 500000 or less. The number-average molecular weight (Mn) of the polyester resin may be 2000 or more and 100000 or less. The molecular weight distribution, Mw/Mn, of the polyester resin may be 1.5 or more and 100 or less, preferably 2 or more and 60 or less.

The weight- and number-average molecular weights are those measured by gel permeation chromatography (GPC). The molecular weight measurement by GPC uses Tosoh's HLC-8120 GPC chromatograph with Tosoh's TSKgel SuperHM-M column (15 cm) and THF eluate. A molecular-weight calibration curve constructed using monodisperse polystyrene standards is used to calculate the weight- and number-average molecular weights.

The binder resin content may be 40% by mass or more and 95% by mass or less, preferably 50% by mass or more and 90% by mass or less, more preferably 60% by mass or more and 85% by mass or less of the toner particles as a whole.

### Coloring Agent(s)

Examples of coloring agents include pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, and malachite green oxalate; and dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes.

One coloring agent may be used alone, or two or more may be used in combination.

Surface-treated coloring agents may optionally be used, and a combination of a coloring agent and a dispersant may also be used. It is also possible to use multiple coloring agents in combination.

The coloring agent content may be 1% by mass or more and 30% by mass or less, preferably 3% by mass or more and 15% by mass or less, of the toner particles as a whole.

### Release Agent

Examples of release agents include hydrocarbon waxes; natural waxes, such as carnauba, rice, and candelilla waxes; synthesized or mineral/petroleum waxes, such as montan wax; and ester waxes, such as fatty acid esters and montanates. Other release agents may also be used.

The melting temperature of the release agent may be 50° C. or above and 110° C. or below, preferably 60° C. or above and 100° C. or below.

The melting temperature is the “peak melting temperature” as in the methods for determining melting temperatures set forth in JIS K7121-1987 “Testing Methods for Transition Temperatures of Plastics” and is determined from the DSC curve, measured by differential scanning calorimetry (DSC).

The release agent content may be 1% by mass or more and 20% by mass or less, preferably 5% by mass or more and 15% by mass or less, of the toner particles as a whole.

### Other Additives

Examples of other additives include known additives, such as magnetic substances, charge control agents, and inorganic powders. Such additives are contained in the toner particles as internal additives.

### Characteristics and Other Details of the Toner Particles

The toner particles may be single-layer ones or may be “core-shell” ones, i.e., toner particles formed by a core (core particle) and a coating that covers the core (shell layer). Core-shell toner particles may be formed by, for example, a core that contains the binder resin(s) and optionally additives, such as coloring agent(s) and a release agent, and a coating that contains the binder resin(s).

The volume-average diameter (D50v) of the toner particles may be 2 μm or more and 10 μm or less, preferably 4 μm or more and 8 μm or less.

The volume-average diameter (D50v) of the toner particles is that measured using Coulter Multisizer II (Beckman Coulter) and ISOTON-II electrolyte (Beckman Coulter). The measurement starts with adding a sample weighing 0.5 mg or more and 50 mg or less to 2 ml of a 5% by mass aqueous solution of a surfactant (e.g., a sodium alkylbenzene sulfonate), which will serve as a dispersant. The resulting dispersion is added to 100 ml or more and 150 ml or less of the electrolyte. The electrolyte with the suspended sample therein is sonicated for 1 minute using a sonicator, and the size distribution of particles having a diameter of 2 μm or more and 60 μm or less is measured using Coulter Multisizer II with an aperture size of 100 μm. The number of particles sampled is 50000.

### External Additives

An example of an external additive is inorganic particles. Examples of inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O (TiO₂) n, Al₂O₃·2SiO₂, CaCO₃, MgCO₃, BaSO₄, and MgSO₄.

The surface of inorganic particles used as an external additive may have been rendered hydrophobic. The hydrophobic treatment is done by, for example, immersing the inorganic particles in hydrophobizing agent(s). The hydrophobizing agent(s) can be of any kind, but examples include silane coupling agents, silicone oil, titanate coupling agents, and aluminum coupling agents. One such agent may be used alone, or two or more may be used in combination.

The amount of the hydrophobizing agent(s) is usually, for example, 1 part by mass or more and 10 parts by mass or less per 100 parts by mass of the inorganic particles.

Materials like resin particles (particles of polystyrene, polymethyl methacrylate, melamine resins, etc.) and active cleaning agents (e.g., metal salts of higher fatty acids, typically zinc stearate, and particles of fluoropolymers) are also examples of external additives.

The amount of the external additive(s) may be 0.01% by mass or more and 5% by mass or less, preferably 0.01% by mass or more and 2.0% by mass or less, of the toner particles.

### Production of the Toner

The toner can be obtained by producing the toner particles and then adding external additive(s) to the toner particles. The production of the toner particles can be either by a dry process (e.g., kneading and milling) or by a wet process (e.g., aggregation and coalescence, suspension polymerization, or dissolution and suspension). Any known dry or wet process may be used. Aggregation and coalescence, in particular, may be used to produce the toner particles.

### Image Forming Apparatus and Image Forming Method

An image forming apparatus according to an exemplary embodiment includes an image carrier; a charging component that charges the surface of the image carrier; an electrostatic charge image creating component that creates an electrostatic charge image on the charged surface of the image carrier; a developing component that contains an electrostatic charge image developer and develops, using the electrostatic charge image developer, the electrostatic charge image on the surface of the image carrier to form a toner image; a transfer component that transfers the toner image on the surface of the image carrier to the surface of a recording medium; and a fixing component that fixes the toner image on the surface of the recording medium. The electrostatic charge image developer is an electrostatic charge developer according to the above exemplary embodiment.

The image forming apparatus according to this exemplary embodiment performs an image forming method that includes charging the surface of an image carrier; creating an electrostatic charge image on the charged surface of the image carrier; developing, using an electrostatic charge image developer according to the above exemplary embodiment, the electrostatic charge image on the surface of the image carrier to form a toner image; transferring the toner image on the surface of the image carrier to the surface of a recording medium; and fixing the toner image on the surface of the recording medium (image forming method according to an exemplary embodiment).

The configuration of the image forming apparatus according to this exemplary embodiment can be applied to known types of image forming apparatuses, including a direct-transfer image forming apparatus, which forms a toner image on the surface of an image carrier and transfers it directly to a recording medium; an intermediate-transfer image forming apparatus, which forms a toner image on the surface of an image carrier, transfers it to the surface of an intermediate transfer body (first transfer), and then transfers the toner image on the surface of the intermediate transfer body to the surface of a recording medium (second transfer); an image forming apparatus having a cleaning component that cleans the surface of the image carrier between the transfer of the toner image and charging; and an image forming apparatus having a static eliminator that removes static electricity from the surface of the image carrier by irradiating the surface with antistatic light between the transfer of the toner image and charging.

If the image forming apparatus according to this exemplary embodiment is an intermediate-transfer one, its transfer component may include, for example, an intermediate transfer body, the surface of which is for the toner image to be transferred to; a first transfer component, which transfers the toner image formed on the image carrier to the surface of the intermediate transfer body (first transfer); and a second transfer component, which transfers the toner image on the surface of the intermediate transfer body to the surface of the recording medium (second transfer).

Part of the image forming apparatus according to this exemplary embodiment, e.g., a portion including the developing component, may have a cartridge structure, i.e., a structure that allows the part to be detached from and attached to the image forming apparatus (or may be a process cartridge). An example of a process cartridge is one that includes a developing component that contains an electrostatic charge image developer according to the above exemplary embodiment.

The following describes an example of an image forming apparatus according to this exemplary embodiment, although this is not the only possible form. Some of its structural elements are described with reference to a drawing.

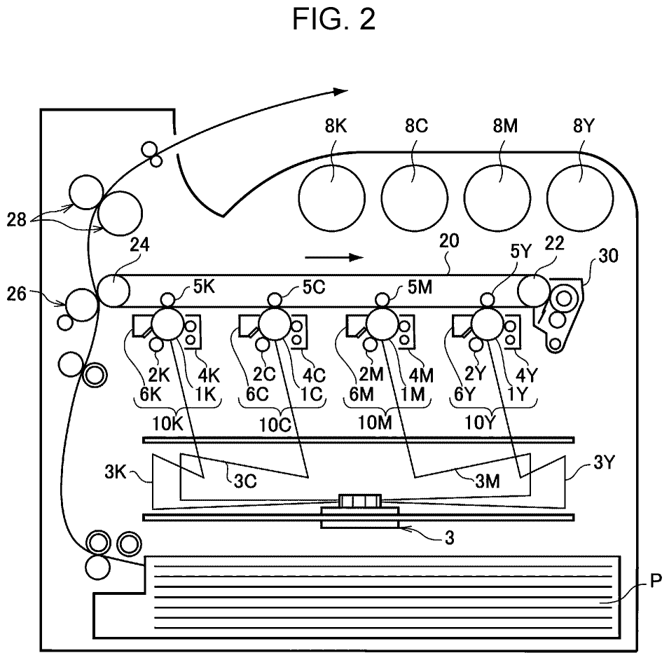

FIG. 2 is a schematic diagram illustrating the structure of an image forming apparatus according to this exemplary embodiment.

The image forming apparatus illustrated in FIG. 2 includes first to fourth electrophotographic image forming units 10Y, 10M, 10C, and 10K (image forming component) that produce images in the colors of yellow (Y), magenta (M), cyan (C), and black (K), respectively, based on color-separated image data. These image forming units (hereinafter also referred to simply as “units”) 10Y, 10M, 10C, and 10K are arranged in a horizontal row with a predetermined distance therebetween. The units 10Y, 10M, 10C, and 10K may be process cartridges, i.e., units that can be detached from and attached to the image forming apparatus.

Above the units 10Y, 10M, 10C, and 10K, an intermediate transfer belt (example of an intermediate transfer body) 20 extends, passing through each unit. The intermediate transfer belt 20 is wound over a drive roller 22 and a support roller 24 and runs in the direction from the first unit 10Y to the fourth unit 10K. The support roller 24 is forced by a spring or similar mechanism, not illustrated in the drawing, to go away from the drive roller 22, thereby placing tension on the intermediate transfer belt 20 wound over the two rollers. On the image-carrying side of the intermediate transfer belt 20 is a cleaning device 30 for the intermediate transfer belt 20 facing the drive roller 22.

The units 10Y, 10M, 10C, and 10K have developing devices (example of a developing component) 4Y, 4M, 4C, and 4K, to which yellow, magenta, cyan, and black toners, respectively, are fed from toner cartridges 8Y, 8M, 8C, and 8K.

The first to fourth units 10Y, 10M, 10C, and 10K are equivalent in structure and operation. The following, therefore, describes the first one 10Y, located upstream of the others in the direction of running of the intermediate transfer belt 20 and producing a yellow image, on behalf of the four.

The first unit 10Y has a photoreceptor 1Y that acts as an image carrier. Around the photoreceptor 1Y are a charging roller (example of a charging component) 2Y that charges the surface of the photoreceptor 1Y to a predetermined potential; an exposure device (example of an electrostatic charge image creating component) 3 that irradiates the charged surface with a laser beam 3Y generated on the basis of a color-separated image signal to create an electrostatic charge image there; a developing device (example of a developing component) 4Y that feeds charged toner to the electrostatic charge image to develop the electrostatic charge image; a first transfer roller (example of a first transfer component) 5Y that transfers the developed toner image to the intermediate transfer belt 20; and a photoreceptor cleaning device (example of a cleaning component) 6Y that removes residual toner off the surface of the photoreceptor 1Y after the first transfer, arranged in this order.

The first transfer roller 5Y is inside the intermediate transfer belt 20 and faces the photoreceptor 1Y. The first transfer roller 5Y, 5M, 5C, or 5K of each unit is connected to a bias power supply (not illustrated) that applies a first transfer bias to the roller. Each bias power supply is controlled by a controller, not illustrated in the drawing, to change the value of the transfer bias it applies to the corresponding first transfer roller.

The formation of a yellow image at the first unit 10Y may be as described below.

First, before the image formation, the charging roller 2Y charges the surface of the photoreceptor 1Y to a potential of −600 V to −800 V.

The photoreceptor 1Y is a stack of an electrically conductive substrate (e.g., having a volume resistivity at 20° C. of 1×10⁻⁶ Ω·cm or less) and a photosensitive layer thereon. The photosensitive layer is of high electrical resistance (has the typical resistance of resin) in its normal state, but when it is irradiated with a laser beam, the resistivity of the irradiated portion changes. Thus, a laser beam 3Y is emitted from the exposure device 3 onto the charged surface of the photoreceptor 1Y in accordance with data for the yellow image sent from a controller, not illustrated in the drawing. This will create an electrostatic charge image as a pattern for the yellow image on the surface of the photoreceptor 1Y.

The electrostatic charge image is an image created on the surface of the photoreceptor 1Y by electrical charging and is a so-called negative latent image; it is created as a result of the charge on the surface of the photoreceptor 1Y flowing away in the irradiated portion of the photosensitive layer in response to a resistivity decrease caused by the exposure to the laser beam 3Y while staying in the portion of the photosensitive layer not irradiated with the laser beam 3Y.

The electrostatic charge image created on the photoreceptor 1Y moves to a predetermined development point as the photoreceptor 1Y rotates. At this development point, the electrostatic charge image on the photoreceptor 1Y is developed into a toner image, or visualized, by the developing device 4Y.

Inside the developing device 4Y is an electrostatic charge image developer that contains, for example, at least yellow toner and a carrier. The yellow toner is on a developer roller (example of a developer carrier) and has been triboelectrically charged with the same polarity as the charge on the photoreceptor 1Y (negative) as a result of being stirred inside the developing device 4Y. As the surface of the photoreceptor 1Y passes through the developing device 4Y, the yellow toner electrostatically adheres to the uncharged, latent-image area of the surface of the photoreceptor 1Y and develops the latent image. The photoreceptor 1Y, now having a yellow toner image thereon, then continues rotating at a predetermined speed, transporting the toner image developed thereon to a predetermined first transfer point.

After the arrival of the yellow toner image on the photoreceptor 1Y at the first transfer point, a first transfer bias is applied to the first transfer roller 5Y, and an electrostatic force acts on the toner image in the direction from the photoreceptor 1Y toward the first transfer roller 5Y to cause the toner image to be transferred from the photoreceptor 1Y to the intermediate transfer belt 20. The applied transfer bias has the (+) polarity, opposite the polarity of the toner (−), and its amount has been controlled by a controller (not illustrated). For example, for the first unit 10Y, it has been controlled to +10 μA.

Residual toner on the photoreceptor 1Y is removed and collected at the photoreceptor cleaning device 6Y.

The first transfer biases applied to the first transfer rollers 5M, 5C, and 5K of the second, third, and fourth units 10M, 10C, and 10K have also been controlled in the same way as that at the first unit 10Y.

The intermediate transfer belt 20 to which a yellow toner image has been transferred at the first unit 10Y in this way is then transported passing through the second to fourth units 10M, 10C, and 10K sequentially, and toner images in the respective colors are overlaid to complete multilayer transfer.

The intermediate transfer belt 20 that has passed through the first to fourth units and thereby completed multilayer transfer of toner images in four colors then reaches a second transfer section formed by the intermediate transfer belt 20, the support roller 24, which touches the inner surface of the intermediate transfer belt 20, and a second transfer roller (example of a second transfer component) 26, which is on the image-carrying side of the intermediate transfer belt 20. Recording paper (example of a recording medium) P is fed to the point of contact between the second transfer roller 26 and the intermediate transfer belt 20 in a timed manner by a feeding mechanism, and a second transfer bias is applied to the support roller 24. The applied transfer bias has the (−) polarity, the same as the polarity of the toner (−), and an electrostatic force acts on the toner image in the direction from the intermediate transfer belt 20 toward the recording paper P to cause the toner image to be transferred from the intermediate transfer belt 20 to the recording paper P. The amount of the second transfer bias has been controlled and is determined in accordance with resistance detected by a resistance detector (not illustrated) that detects the electrical resistance of the second transfer section.

After that, the recording paper P is delivered to the point of pressure contact (nip) between a pair of fixing rollers at a fixing device (example of a fixing component) 28, and the toner image is fixed on the recording paper P there to give a fixed image.

The recording paper P to which the toner image is transferred can be, for example, ordinary printing paper for copiers, printers, etc., of electrophotographic type. Recording media such as overhead-projector (OHP) sheets may also be used.

The use of recording paper P having a smooth surface may help further improve the smoothness of the surface of the fixed image. For example, coated paper, which is paper with a resin or other coating on its surface, or art paper for printing may be used.

The recording paper P with a completely fixed color image thereon is transported to an ejection section to finish the formation of a color image.

### Process Cartridge

A process cartridge according to an exemplary embodiment is one attachable to and detachable from an image forming apparatus and includes a developing component that contains an electrostatic charge image developer according to the above exemplary embodiment and develops, using the electrostatic charge image developer, an electrostatic charge image created on the surface of an image carrier to form a toner image.

This is not the only possible configuration of a process cartridge according to this exemplary embodiment. The process cartridge may optionally have at least one extra component selected from an image carrier, a charging component, an electrostatic charge image creating component, a transfer component, etc., besides the developing component.

The following describes an example of a process cartridge according to this exemplary embodiment, although this is not the only possible form. Some of its structural elements are described with reference to a drawing.

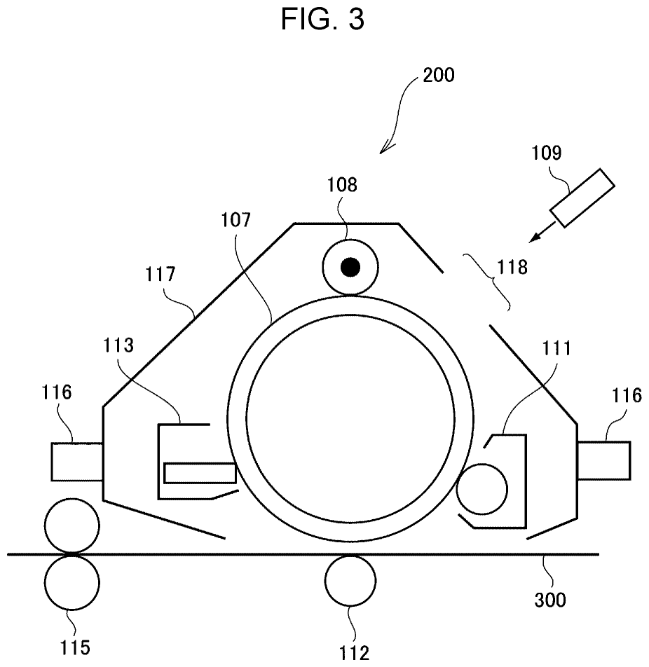

FIG. 3 is a schematic diagram illustrating the structure of a process cartridge according to this exemplary embodiment.

The process cartridge 200 illustrated in FIG. 3 is a cartridge containing, for example, a photoreceptor 107 (example of an image carrier) and a charging roller 108 (example of a charging component), a developing device 111 (example of a developing component), and a photoreceptor cleaning device 113 (example of a cleaning component) arranged around the photoreceptor 107, all held together in a housing 117 having attachment rails 116 and an opening 118 for exposure to light.

FIG. 3 also illustrates an exposure device (example of an electrostatic charge image creating component) 109, a transfer device (example of a transfer component) 112, a fixing device (example of a fixing component) 115, and recording paper (example of a recording medium) 300.

### EXAMPLES

The following describes the above exemplary embodiments in more specific terms by providing examples, although these examples are not the only possible forms of the above exemplary embodiments. The syntheses, treatments, production, etc., are carried out at room temperature (25° C.±3° C.) unless stated otherwise. In the following description, “parts” and “%” are all by mass unless stated otherwise.

### Production of Toners

### Production of Amorphous Polyester Resin Dispersion (A1)

Ethylene glycol: 37 parts
Neopentyl glycol: 65 parts
1,9-Nonanediol: 32 parts
Terephthalic acid: 96 parts

These materials are put into a reactor and heated to a temperature of 200° C. over 1 hour. After the reaction system has been stirred to uniformity, 1.2 parts of dibutyltin oxide is added. The temperature is increased to 240° C. over 6 hours while water is removed by distillation while it is formed, and stirring is continued for 4 hours at 240° C. This gives an amorphous polyester resin (acid value, 9.4 mg KOH/g; weight-average molecular weight, 13,000; glass transition temperature, 62° C.). The molten amorphous polyester resin is transferred to an emulsifier-disperser (Cavitron CD1010, Eurotec) at a speed of 100 g per minute. Separately, reagent-grade aqueous ammonia is diluted with deionized water to a concentration of 0.37%. The resulting dilute aqueous ammonia is put into a tank and then, simultaneously with the amorphous polyester resin, transferred to the emulsifier-disperser at a speed of 0.1 liters per minute while being heated to 120° C. in a heat exchanger. The emulsifier-disperser is operated at a rotor frequency of 60 Hz and a pressure of 5 kg/cm². This gives amorphous polyester resin dispersion (A1), a liquid dispersion having a volume-average diameter of particles of 160 nm and a solids content of 20%.

### Production of Crystalline Polyester Resin Dispersion (C1)

Decanedioic acid: 81 parts
Hexanediol: 47 parts

These materials are put into a reactor and heated to a temperature of 160° C. over 1 hour. After the reaction system has been stirred to uniformity, 0.03 parts of dibutyltin oxide is added. The temperature is increased to 200° C. over 6 hours while water is removed by distillation while it is formed, and stirring is continued for 4 hours at 200° C. Then the reaction solution is cooled until solids separate out, and the solids are collected and dried at a temperature of 40° C. under reduced pressure. This gives crystalline polyester resin (C1) (melting point, 64° C.; weight-average molecular weight, 15,000).
Crystalline polyester resin (C1): 50 parts
An anionic surfactant (DKS Co., Ltd., Neogen RK): 2 parts
Deionized water: 200 parts

These materials are heated to 120° C. and sufficiently dispersed using a homogenizer (ULTRA-TURRAX T50, IKA). The resulting dispersion is subjected to further dispersion using a pressure-pump homogenizer and collected when the volume-average diameter of particles is 180 nm. The resulting dispersion is crystalline polyester resin dispersion (C1), a liquid dispersion having a solids content of 20%.

### Production of Release Agent Particles Dispersion (W1)

A paraffin wax (Nippon Seiro Co., Ltd., HNP-9): 100 parts
An anionic surfactant (DKS Co., Ltd., Neogen RK): 1 part
Deionized water: 350 parts

These materials are mixed together, and the resulting mixture is heated to 100° C. The mixture is dispersed using a homogenizer (IKA ULTRA-TURRAX T50) and then using a pressure-pump Gaulin homogenizer, giving a liquid dispersion in which release-agent particles having a volume-average diameter of 200 nm are dispersed. Deionized water is added to this liquid dispersion of release-agent particles to a solids content of 20%. The resulting dispersion is release agent particles dispersion (W1).

### Production of Coloring Agent Particles Dispersion (K1)

Carbon black (Cabot, Regal 330): 50 parts
An anionic surfactant (DKS Co., Ltd., Neogen RK): 5 parts
Deionized water: 195 parts

These materials are mixed together and dispersed for 60 minutes using a high-pressure impact disperser (Ultimaizer HJP30006, Sugino Machine). This gives coloring agent particles dispersion (K1), a liquid dispersion having a solids content of 20%.

### Production of Coloring Agent Particles Dispersion (C1)

A cyan pigment (Pigment Blue 15:3, Dainichiseika Color & Chemicals Mfg.): 50 parts
An anionic surfactant (DKS Co., Ltd., Neogen RK): 5 parts
Deionized water: 195 parts

These materials are mixed together and dispersed for 60 minutes using a high-pressure impact disperser (Ultimaizer HJP30006, Sugino Machine). This gives coloring agent particles dispersion (C1), a liquid dispersion having a solids content of 20%.

### Production of Coloring Agent Particles Dispersion (M1)

A magenta pigment (Pigment Red 122, DIC): 50 parts
An anionic surfactant (DKS Co., Ltd., Neogen RK): 5 parts
Deionized water: 195 parts

These materials are mixed together and dispersed for 60 minutes using a high-pressure impact disperser (Ultimaizer HJP30006, Sugino Machine). This gives coloring agent particles dispersion (M1), a liquid dispersion having a solids content of 20%.

### Production of Coloring Agent Particles Dispersion (Y1)

A yellow pigment (Pigment Yellow 74, Dainichiseika Color & Chemicals Mfg.): 50 parts
An anionic surfactant (DKS Co., Ltd., Neogen RK): 5 parts
Deionized water: 195 parts

These materials are mixed together and dispersed for 60 minutes using a high-pressure impact disperser (Ultimaizer HJP30006, Sugino Machine). This gives coloring agent particles dispersion (Y1), a liquid dispersion having a solids content of 20%.

### Production of Black Toner Particles (K1)

Deionized water: 200 parts
Amorphous polyester resin dispersion (A1): 150 parts
Crystalline polyester resin dispersion (C1): 10 parts
Release agent particles dispersion (W1): 10 parts
Coloring agent particles dispersion (K1): 15 parts
An anionic surfactant (TaycaPower): 2.8 parts

These materials are put into a reactor, the pH is adjusted to 3.5 with 0.1 N nitric acid, and then an aqueous solution of 2 parts of polyaluminum chloride (Oji Paper Co., Ltd.; 30% powder) in 30 parts of deionized water is added. The resulting mixture is dispersed at 30° C. using a homogenizer (IKA ULTRA-TURRAX T50), heated to 45° C. in an oil bath for heating, and maintained in that state until the volume-average diameter of particles is 4.9 μm. Then 60 parts of amorphous polyester resin dispersion (A1) is added, and the mixture is allowed to stand for 30 minutes. When the volume-average diameter of particles is 5.2 μm, another 60 parts of amorphous polyester resin liquid dispersion (A1) is added, and the mixture is allowed to stand for 30 minutes. Then 20 parts of a 10% aqueous solution of a metal salt of NTA (nitrilotriacetic acid) (CHELEST 70, Chelest Corporation) is added, and the pH is adjusted to 9.0 with a 1 N aqueous solution of sodium hydroxide. The resulting mixture is heated to 85° C. with continued stirring with 1 part of the anionic surfactant (TaycaPower) and maintained in that state for 5 hours. The resulting mixture is cooled to 20° C. at a rate of 20° C./min and filtered, and the residue is washed thoroughly with deionized water and dried. This gives black toner particles (K1), having a volume-average diameter of 5.7 μm and an average circularity of 0.971.

### Production of Cyan Toner Particles (C1)

Cyan toner particles (C1) are produced in the same way as black toner particles (K1), except that coloring agent particles dispersion (K1) is changed to coloring agent particles dispersion (C1).

### Production of Magenta Toner Particles (M1)

Magenta toner particles (M1) are produced in the same way as black toner particles (K1), except that coloring agent particles dispersion (K1) is changed to coloring agent particles dispersion (M1).

### Production of Yellow Toner Particles (Y1)

Yellow toner particles (Y1) are produced in the same way as black toner particles (K1), except that coloring agent particles dispersion (K1) is changed to coloring agent particles dispersion (Y1).

### Production of Black Toner (K1)

In a sample mill, 100 parts by mass of black toner particles (K1) and 1.5 parts by mass of hydrophobic silica particles (RY50, Nippon Aerosil) are mixed together for 30 seconds at a rotational frequency of 10000 rpm. The resulting mixture is screened through a 45-μm mesh vibrating sieve. This gives black toner (K1), having a volume-average diameter of particles of 5.7 μm.

### Production of Cyan Toner (C1)

Cyan toner (C1) is produced in the same way as black toner (K1), except that black toner particles (K1) are changed to cyan toner particles (C1).

### Production of Magenta Toner (M1)

Magenta toner (M1) is produced in the same way as black toner (K1), except that black toner particles (K1) are changed to magenta toner particles (M1).

### Production of Yellow Toner (Y1)

Yellow toner (Y1) is produced in the same way as black toner (K1), except that black toner particles (K1) are changed to yellow toner particles (Y1).

### Example 1

MnMg ferrite particles (volume-average diameter of particles, 35 μm): 100 parts
First resin particles: Styrene-methyl methacrylate copolymer resin particles (ratio in the polymer by mass, 2:8; weight-average molecular weight, 500,000): 3.5 parts
Silica particles (HM30S, Tokuyama Corporation; average diameter of primary particles, 8 nm): 1.4 parts

These materials are stirred and mixed together in a bladed stirrer-mixer for 15 minutes at a blade circumferential velocity of 10.0 m/sec and a stirrer-mixer internal temperature of 20° C. This attaches the resin particles and the silica particles to the MnMg ferrite particles.

The MnMg ferrite particles with the resin particles and the silica particles adhering thereto are fed continuously into the feedstock inlet of an extruder (TEM50 continuous twin-screw extruder, Toshiba Machine Co., Ltd.). The extruder's temperature for heating the casing is set to 250° C., and the processed particles (approximately 190° C.) are collected at the outlet.

The collected particles are fed continuously to COMIL grinder (punched metal with a pore diameter of 1 mm), cooled while being crushed into primary particles, and collected as crushed particles at a temperature of 60° C. or below. The crushed particles are then screened through a 75-μm mesh sieve to eliminate coarse particles. This gives a carrier.

One hundred parts of the carrier and 20 parts of black toner (K1) are stirred in a V-blender for 20 minutes. The resulting mixture is screened through a 212-μm sieve to complete a developer in the color of black.

One hundred parts of the carrier and 20 parts of cyan toner (C1) are stirred in a V-blender for 20 minutes. The resulting mixture is screened through a 212-μm sieve to complete a developer in the color of cyan.

One hundred parts of the carrier and 20 parts of magenta toner (M1) are stirred in a V-blender for 20 minutes. The resulting mixture is screened through a 212-μm sieve to complete a developer in the color of magenta.

One hundred parts of the carrier and 20 parts of yellow toner (Y1) are stirred in a V-blender for 20 minutes. The resulting mixture is screened through a 212-μm sieve to complete a developer in the color of yellow.

### Examples 2 to 5

The carriers of Examples 2 to 5 are produced as in Example 1. The amount of the first resin particles (styrene-methyl methacrylate copolymer resin particles) and that of the silica particles, however, are increased or reduced.

As in Example 1, the developers of Examples 2 to 5 are produced from the carriers of Examples 2 to 5 and toners in different colors.

### Examples 6 to 10

The carriers of Examples 6 to 10 are produced as in Example 1. The amount of the first resin particles (styrene-methyl methacrylate copolymer resin particles) and that of the silica particles, however, are increased or reduced. Second resin particles and electrically conductive particles are also used.

As in Example 1, the developers of Examples 6 to 10 are produced from the carriers of Examples 6 to 10 and toners in different colors.

The details of the second resin particles and electrically conductive particles, used in Examples 6 to 10, are as follows.
Second resin particles: Melamine resin particles (EPOSTAR FS, Nippon Shokubai Co., Ltd.; average diameter of primary particles, 200 nm)
Electrically conductive particles: Carbon black (VXC72, Cabot; average diameter of primary particles, 30 nm) Comparative Example 1
MnMg ferrite particles (volume-average diameter of particles, 35 μm): 100 parts
First resin particles: Styrene-methyl methacrylate copolymer resin particles (ratio in the polymer by mass, 2:8; weight-average molecular weight, 500,000): 2.65 parts
Second resin particles: Melamine resin particles (EPOSTAR FS, Nippon Shokubai Co., Ltd.; average diameter of primary particles, 200 nm): 0.265 parts
Electrically conductive particles: Carbon black (VXC72, Cabot; average diameter of primary particles, 30 nm): 0.265 parts

These materials are stirred and mixed together in a bladed stirrer-mixer for 15 minutes at a blade circumferential velocity of 10.0 m/sec and a stirrer-mixer internal temperature of 20° C. This attaches the resin particles and the silica particles to the MnMg ferrite particles.

The MnMg ferrite particles with the resin particles and the silica particles adhering thereto are fed continuously into the feedstock inlet of an extruder (TEM50 continuous twin-screw extruder, Toshiba Machine Co., Ltd.). The extruder's temperature for heating the casing is set to 250° C., and the processed particles (approximately 190° C.) are collected at the outlet.

The collected particles are fed continuously to COMIL grinder (punched metal with a pore diameter of 1 mm), cooled while being crushed into primary particles, and collected as crushed particles at a temperature of 60° C. or below. The crushed particles are then screened through a 75-μm mesh sieve to eliminate coarse particles. This gives a carrier.

As in Example 1, the developers of Comparative Example 1 are produced from the carrier of Comparative Example 1 and toners in different colors.

### Comparative Example 2

MnMg ferrite particles (volume-average diameter of particles, 35 μm): 100 parts
A styrene-methyl methacrylate copolymer (ratio in the polymer by mass, 2:8; weight-average molecular weight, 500,000): 2.0 parts
Silica particles (HM30S, Tokuyama Corporation; average diameter of primary particles, 8 nm): 0.8 parts
Toluene: 5 parts

The styrene-methyl methacrylate copolymer, the silica particles, and the toluene are stirred in a sand mill for 30 minutes at a rotational frequency of 1200 rpm together with glass beads (diameter, 1 mm; the same amount as toluene) to give a solution.

The resulting solution, for the formation of the coating layer, is put into a vacuum-degassing kneader together with the MnMg ferrite particles, and the materials are stirred at 40 rpm with warming and pressure reduction over 30 minutes so that the toluene will be distilled away. The particles are removed from the kneader and screened through a 75-μm mesh sieve to eliminate coarse particles. This gives a carrier.

As in Example 1, the developers of Comparative Example 2 are produced from the carrier of Comparative Example 2 and toners in different colors.

### Comparative Example 3

MnMg ferrite particles (volume-average diameter of particles, 35 μm): 100 parts
A styrene-methyl methacrylate copolymer (ratio in the polymer by mass, 2:8; weight-average molecular weight, 500,000): 2.0 parts
Silica particles (HM30S, Tokuyama Corporation; average diameter of primary particles, 8 nm): 0.8 parts
Toluene: 10 parts

The styrene-methyl methacrylate copolymer, the silica particles, and the toluene are stirred in a sand mill for 30 minutes at a rotational frequency of 1200 rpm together with glass beads (diameter, 1 mm; the same amount as toluene) to give a solution.

In a 70° C. atmosphere, the resulting solution, for the formation of the coating layer, is applied to the surface of the MnMg ferrite particles using SPIRA COTA (Okada Seiko) at a rate of 30 g/min and dried. The target amount of the finished coating layer is 2.8 parts per 100 parts of the MnMg ferrite particles. The dried powder is removed from the coater and screened through a 75-μm mesh sieve to eliminate coarse particles. This gives a carrier.

As in Example 1, the developers of Comparative Example 3 are produced from the carrier of Comparative Example 3 and toners in different colors.

### Comparative Example 4

MnMg ferrite particles (volume-average diameter of particles, 35 μm): 100 parts
First resin particles: Styrene-methyl methacrylate copolymer resin particles (ratio in the polymer by mass, 2:8; weight-average molecular weight, 500,000): 2.0 parts
Silica particles (HM30S, Tokuyama Corporation; average diameter of primary particles, 8 nm): 0.8 parts

These materials are stirred and mixed together in a bladed stirrer-mixer for 15 minutes at a blade circumferential velocity of 10.0 m/sec and a stirrer-mixer internal temperature of 20° C. This attaches the resin particles and the silica particles to the MnMg ferrite particles.

The temperature inside the stirrer-mixer is set to 140° C., and the materials are stirred and mixed together for 15 minutes at a blade circumferential velocity of 5.0 m/s. The resulting powder is removed from the stirrer-mixer and screened through a 75-μm mesh sieve to eliminate coarse particles. This gives a carrier.

As in Example 1, the developers of Comparative Example 4 are produced from the carrier of Comparative Example 4 and toners in different colors.

### Performance Testing

### Resistance Retention

Before and after the image formation for void testing, a developer is removed from the developer unit, and the carrier is collected by separating the developer into toner and the carrier by blowing air to it. The electrical volume resistance of this carrier sample is measured as follows.

On the surface of a round jig having 20-cm² plate electrodes, the carrier is spread to form a flat layer with a thickness of 1 mm or more and 3 mm or less. A 20-cm² plate electrode is placed on this layer to sandwich the layer between the electrodes. A load of 4 kg is placed on the upper electrode to eliminate any space between the carrier particles, and then the thickness of the layer (cm) is measured. The two electrodes, on and below the layer, are connected to an electrometer and a high-voltage power supply. A high voltage is applied to the electrodes to produce an electric field of 103.8 V/cm, and the current reading (A) is recorded. The measurement is performed at a temperature of 20° C. and a relative humidity of 50%, and the electrical volume resistance R (Ω·cm) of the carrier is calculated according to the following equation.

$$R = E \times 20 / ( I - {I}_{0} ) / L$$

In the equation, R represents the electrical volume resistance (Ω·cm) of the carrier, E represents the applied voltage (V), I represents electrical current (A), I₀ represents the electrical current (A) at an applied voltage of 0 V, and L represents the thickness (cm) of the layer. The coefficient 20 is the area (cm²) of the plate electrodes.

The percentage resistance retention is calculated as Rend/Rini×100, where Rini is the electrical volume resistance before the image formation, and Rend is that after the image formation. The carrier is graded by the percentage resistance retention according to the criteria below. The results are presented in Table 1. Higher percentages of resistance retention are better, and grades A to C are practically acceptable.
A: Higher than 90%
B: Higher than 80% and 90% or lower
C: Higher than 70% and 80% or lower
D: Higher than 65% and 70% or lower
E: 65% or lower

### Voids in an Image

The developers of the Example or Comparative Example are set in the developer unit of DocuCentre Color 400 (Fuji Xerox Co., Ltd.). At a temperature of 28.5° C. and a relative humidity of 85%, a 1% coverage image is printed continuously on 100,000 sheets of A4-sized paper (FUJIFILM Business Innovation Corp., J paper), and then a 30% coverage secondary-color image continuously on 500 sheets. Then a 100% density tertiary-color (process black) image with a transferred mass per area of 9.8 g/cm² is printed continuously on ten sheets of A4-sized paper (Ricoh Co., Ltd., “45” paper; grammage, 52 g/m²). The secondary-color image on the last ten of the 500 sheets and the tertiary-color image on the ten sheets are visually inspected, and the carrier is graded by whether the images have white spots and the quality of the images according to the criteria below. The results are presented in Table 1. Grades A to C are practically acceptable.
A: No white spot and no color unevenness.
B: No white spot, but minor color unevenness is noticed in some areas of the tertiary-color images.
C: No white spot, but minor color unevenness is noticed in some areas of the secondary- and tertiary-color images.
D: The tertiary-color images have white spots.
E: The secondary- and tertiary-color images have white spots.

TABLE 1

| | | | | | | | | Carrier structure | | | | |
|---|---|---|---|---|---|---|---|---|---|---|---|---|
| | | | | | | | | Ratio by | | | | |
| | | | | | | | | mass | | | | |
| | | | | | | | | between | | | | |
| | | Carrier materials | | | | | | the base | | | | |
| | | | Coating layer | | | | | resin for | Percentage | | | |
| | | | First | | Second | Electrically | | the coating | exposure | Percentage | Performance | |
| | | Ferrite | resin | Silica | resin | conductive | Total | layer and | of the | gap area to | testing | |
| | | particles | particles | particles | particles | particles | Parts | the silica | magnetic | the carrier | | Voids |
| | Production | Parts by | Parts by | Parts by | Parts by | Parts by | by | particles | particles | area | Resistance | in an |
| | method | mass | mass | mass | mass | mass | mass | — | % | % | retention | image |
| Example 1 | Extruder | 100 | 3.5 | 1.4 | 0 | 0 | 4.9 | 100:40 | 0.0 | 3.00 | B | A |
| Example 2 | Extruder | 100 | 2.0 | 0.8 | 0 | 0 | 2.8 | 100:40 | 3.0 | 1.00 | B | B |
| Example 3 | Extruder | 100 | 1.5 | 0.6 | 0 | 0 | 2.1 | 100:40 | 5.0 | 0.50 | A | B |
| Example 4 | Extruder | 100 | 2.0 | 0.4 | 0 | 0 | 2.4 | 100:20 | 4.0 | 0.70 | A | B |
| Example 5 | Extruder | 100 | 2.0 | 1.2 | 0 | 0 | 3.2 | 100:60 | 2.0 | 1.50 | A | A |
| Example 6 | Extruder | 100 | 2.0 | 0.8 | 0.2 | 0.2 | 3.2 | 100:40 | 2.0 | 0.30 | A | A |
| Example 7 | Extruder | 100 | 2.0 | 0.4 | 0.2 | 0.2 | 2.8 | 100:20 | 3.1 | 0.05 | A | B |
| Example 8 | Extruder | 100 | 2.0 | 1.2 | 0.2 | 0.2 | 3.6 | 100:60 | 0.5 | 0.50 | A | A |
| Example 9 | Extruder | 100 | 3.0 | 1.2 | 0.3 | 0.3 | 4.8 | 100:40 | 0.0 | 0.70 | A | A |
| Example 10 | Extruder | 100 | 1.5 | 0.6 | 0.15 | 0.15 | 2.4 | 100:40 | 3.8 | 0.05 | A | B |
| Comparative | Extruder | 100 | 2.65 | 0 | 0.265 | 0.265 | 3.18 | 100:0 | 1.0 | 6.00 | D | C |
| Example 1 | | | | | | | | | | | | |
| Comparative | Kneader | 100 | 2.0 | 0.8 | 0 | 0 | 2.8 | 100:40 | 10.0 | 3.00 | B | D |
| Example 2 | | | | | | | | | | | | |
| Comparative | Spray | 100 | 2.0 | 0.8 | 0 | 0 | 2.8 | 100:40 | 3.0 | 12.00 | E | E |
| Example 3 | dryer | | | | | | | | | | | |
| Comparative | Henschel | 100 | 2.0 | 0.8 | 0 | 0 | 2.8 | 100:40 | 0.0 | 10.00 | E | D |
| Example 4 | mixer | | | | | | | | | | | |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing a carrier for developing an electrostatic charge image, the carrier comprising: magnetic particles; and a coating layer covering the magnetic particles, the method comprising:
dry-attaching base resin particles for the coating layer and the inorganic particles to a surface of the magnetic particles; and
passing the magnetic particles, with the base resin particles and the inorganic particles adhering thereto, continuously through an extruder at a temperature at which the resin particles melt.

2. The method according to claim 1, wherein, in the cross-sectional observation, a gap lies at least in part between the magnetic particles and the coating layer, and the percentage area of the gap is 0.05% or more and 3% or less.

3. The method according to claim 1, wherein the coating layer comprises 25 parts by mass or more and 40 parts by mass or less of the inorganic particles per 100 parts by mass of the resin.

4. The method according to claim 1, wherein an average diameter of primary particles of the inorganic particles is 1 nm or more and 80 nm or less.

5. The method according to claim 1, wherein the inorganic particles include silica particles.

6. The method according to claim 1, wherein the coating layer further comprises resin particles.

7. The method according to claim 1, wherein the coating layer further comprises electrically conductive particles.

8. The method according to claim 1, wherein the magnetic particles are ferrite particles.

9. An electrostatic charge image developer comprising a toner and the carrier produced by the method according to claim 1.

10. A process cartridge attachable to and detachable from an image forming apparatus, the process cartridge comprising:
a developing component that comprises the electrostatic charge image developer according to claim 9 and develops, using the electrostatic charge image developer, an electrostatic charge image on a surface of an image carrier to form a toner image.

11. An image forming apparatus comprising:
an image carrier;
a charging component configured to charge a surface of the image carrier;
an electrostatic charge image creating component configured to create an electrostatic charge image on the charged surface of the image carrier;
a developing component that comprises the electrostatic charge image developer according to claim 9 and is configured to develop, using the electrostatic charge image developer, the electrostatic charge image on the surface of the image carrier to form a toner image;
a transfer component configured to transfer the toner image on the surface of the image carrier to a surface of a recording medium; and
a fixing component configured to fix the toner image on the surface of the recording medium.

12. An image forming method comprising:
charging a surface of an image carrier;
creating an electrostatic charge image on the charged surface of the image carrier;
developing, using the electrostatic charge image developer according to claim 9, the electrostatic charge image on the surface of the image carrier to form a toner image;
transferring the toner image on the surface of the image carrier to a surface of a recording medium; and
fixing the toner image on the surface of the recording medium.
